(19) United States
(12) Patent Application Publication
(10) Pub. No.: US 2026/0352798 A1
(43) Pub. Date: Nov. 5, 2026

(54) NAKED-EYE THREE-DIMENSIONAL DISPLAY METHOD, SYSTEM, VEHICLE, COMPUTER DEVICE, AND MEDIUM

(71) Applicant: SHANGHAI TIANMA MICROELECTRONICS CO., LTD., Shanghai (CN)

(72) Inventors: Yang ZENG, Shanghai (CN); Yuan DING, Shanghai (CN)

(73) Assignee: SHANGHAI TIANMA MICROELECTRONICS CO., LTD., Shanghai (CN)

(21) Appl. No.: 19/724,932

(22) Filed: Jun. 30, 2026

(30) Foreign Application Priority Data
Mar. 5, 2026 (CN) 202610268471.3

(51) Int. Cl. H04N 13/398; G06T 7/70; H04N 13/156; H04N 13/302; H04N 13/346; H04N 13/383

(52) U.S. Cl. CPC H04N 13/398; G06T 7/70; H04N 13/156; H04N 13/302; H04N 13/346; H04N 13/383; G06T 2207/30196

(57) ABSTRACT

A naked-eye three-dimensional display method, system, vehicle, computer device, and medium are provided. The method includes: acquiring a stable human eye coordinate and a predicted human eye coordinate, where the predicted human eye coordinate is different from the stable human eye coordinate, and the predicted human eye coordinate is a human eye coordinate obtained by prediction and indicates a spatial position of a human eye at an image display instant; generating, according to the stable human eye coordinate and the predicted human eye coordinate, a display image for transmission to a display. The embodiment of the present application achieves both image stability and image correctness in fast dynamic scenes, thereby improving the user's viewing experience.

### CROSS-REFERENCES TO RELATED APPLICATIONS

This application claims benefit of priority to Chinese patent application NO. 202610268471.3, titled “NAKED-EYE THREE-DIMENSIONAL DISPLAY METHOD, SYSTEM, VEHICLE, COMPUTER DEVICE, AND MEDIUM”, filed Mar. 5, 2026, with the China National Intellectual Property Administration, the entire of which is incorporated herein by reference.

### FIELD

The present disclosure relates to the field of display technology, and in particular, to a naked-eye three-dimensional display method, system, vehicle, computer device, and medium.

### BACKGROUND

Naked-eye three-dimensional (3D) display technology, for example, when applied in a Head-Up Display (HUD), typically uses optical elements to split light rays so that a user's left eye and right eye receive different images with parallax respectively, which are fused to form a three-dimensional visual effect with depth perception in the brain.

To realize naked-eye 3D display, there are mainly two technical paths: multi-viewpoint rendering and two-viewpoint rendering. Although multi-viewpoint rendering technology can provide a degree of viewing angle continuity, its main disadvantages are high crosstalk and image blurring. This is because the system needs to prepare image information in advance for multiple different spatial positions, and the actual propagating light rays have a width. The user's eyes will not only receive image information from the directly facing viewing angle but also receive part of the information from adjacent viewing angles, leading to a decrease in image quality.

In two-viewpoint 3D display systems, to improve image clarity and reduce crosstalk, a rendering method based on real-time human eye tracking is widely adopted.

### SUMMARY

The present disclosure provides a naked-eye three-dimensional display method, system, vehicle, computer device, and medium to achieve both image stability and image correctness in fast dynamic scenes, thereby improving the user's viewing experience.

An embodiment of the present disclosure provides a naked-eye three-dimensional display method, including:
acquiring a stable human eye coordinate and a predicted human eye coordinate, where the predicted human eye coordinate is different from the stable human eye coordinate, and the predicted human eye coordinate is a human eye coordinate obtained by prediction and indicates a spatial position of a human eye at an image display instant;
generating, according to the stable human eye coordinate and the predicted human eye coordinate, a display image for transmission to a display.

An embodiment of the present disclosure provides a naked-eye three-dimensional display system, including:
a human eye tracking device, configured to capture a human eye image;
a processing device, configured to acquire the human eye image, acquire an initial human eye coordinate according to the human eye image, generate a stable human eye coordinate and a predicted human eye coordinate according to the initial human eye coordinate, and generate a display image according to the stable human eye coordinate and the predicted human eye coordinate, where the predicted human eye coordinate is different from the stable human eye coordinate, and the predicted human eye coordinate is a human eye coordinate obtained by prediction and indicates a spatial position of a human eye at an image display instant;
a display, configured to emit light for display based on the display image, to form multiple periodically arranged viewing zones.

An embodiment of the present disclosure provides a vehicle, including the naked-eye three-dimensional display system described in the second aspect.

An embodiment of the present disclosure provides a computer device, including a memory, a processor, and a computer program stored in the memory and executable on the processor, where when executing the program, the processor implements the method described in the first aspect.

An embodiment of the present disclosure provides a computer-readable storage medium, on which a computer program is stored, where the program is executed by a processor to implement the method described in the first aspect.

### BRIEF DESCRIPTION OF THE DRAWINGS

FIG. 1 is a flowchart of a naked-eye three-dimensional display method according to an embodiment;

FIG. 2 is a flowchart of another naked-eye three-dimensional display method according to an embodiment;

FIG. 3 is a schematic diagram of X coordinate values of human eye coordinates at different instants according to an embodiment;

FIG. 4 is a schematic diagram of a 3D image source according to an embodiment;

FIG. 5 is another schematic diagram of human eye coordinates at different instants according to an embodiment;

FIG. 6 is a schematic structural diagram of a display according to an embodiment;

FIG. 7 is a schematic diagram of a prism assembly splitting light rays according to an embodiment;

FIG. 8 is a schematic diagram of an optical path for viewpoint rendering according to an embodiment;

FIG. 9 is another schematic diagram of human eye coordinates at different instants according to an embodiment;

FIG. 10 is a detailed flowchart of step S203;

FIG. 11 is a schematic diagram of a left-right eye allocation chart according to an embodiment;

FIG. 12 is a detailed flowchart of step S204;

FIG. 13 is a schematic diagram of another left-right eye allocation chart according to an embodiment;

FIG. 14 is a schematic diagram of a distribution of viewing zones according to an embodiment;

FIG. 15 is a schematic diagram of another distribution of viewing zones according to an embodiment;

FIG. 16 is a schematic diagram of yet another distribution of viewing zones according to an embodiment;

FIG. 17 is a structural block diagram of a naked-eye three-dimensional display system according to an embodiment;

FIG. 18 is a schematic diagram of a vehicle according to an embodiment;

FIG. 19 is a schematic diagram of an optical path of a vehicle according to an embodiment;

FIG. 20 is a structural schematic diagram of a computer device according to an embodiment.

### DETAILED DESCRIPTION OF THE EMBODIMENTS

The present disclosure is further described below in conjunction with the accompanying drawings and embodiments. The specific embodiments described herein are only used for explaining the present disclosure, rather than limiting the present disclosure. Additionally, the drawings only show parts related to the present disclosure, not the entire structure.

In a two-viewpoint 3D display system, the system needs to dynamically allocate, for each sub-pixel, the content of the left-eye image or right-eye image that should be displayed, i.e., perform viewpoint allocation, based on the user's human eye position acquired in real time. However, this method has extremely high requirements for tracking precision and timeliness. Because there is an inevitable system delay from capturing the human eye position to the final image display, when the user moves quickly or suddenly changes the direction of movement, the image generated based on the delayed position information may not match the actual position of the eyes, causing the user to see incorrect images, resulting in crosstalk and display anomalies such as ghosting.

To compensate for the above system delay, one solution is to estimate the human eye position at a future image display instant through a prediction algorithm based on historical coordinate data acquired by the human eye tracking device, and perform viewpoint allocation based on this predicted position. Although this method can alleviate the crosstalk problem caused by the delay to an extent, it introduces new technical disadvantages. The inherent errors and discreteness of the prediction algorithm itself can cause the predicted coordinate values to have unstable fluctuations over time. This fluctuation of coordinates directly causes the left perspective camera and the right perspective camera to undergo high-frequency and slight back-and-forth jumps, which ultimately manifests as uncomfortable tiny jitters on the display screen, affecting the user's viewing experience. In short, there exists a trade-off difficult to reconcile between resolving the crosstalk caused by the delay and avoiding the screen jitter caused by the prediction.

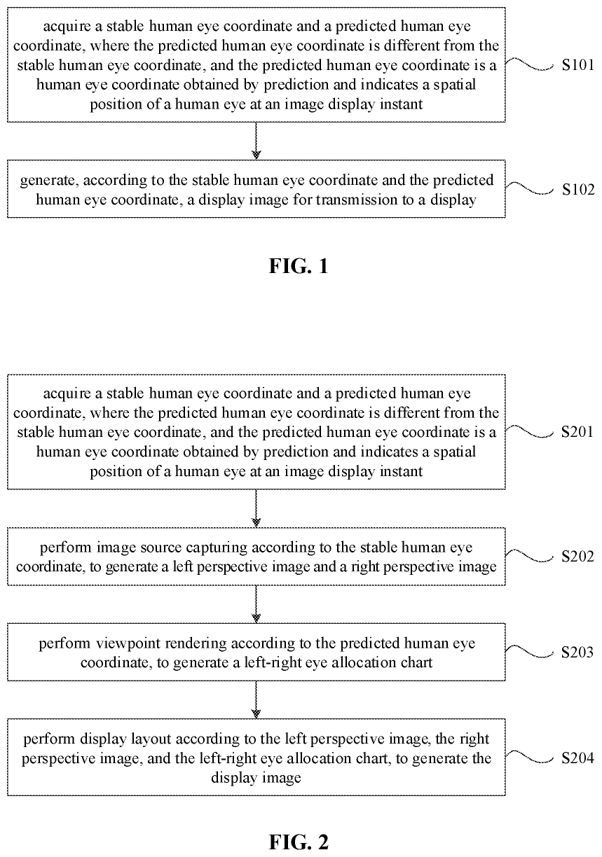

FIG. 1 is a flowchart of a naked-eye three-dimensional display method according to an embodiment. This method can be executed by a naked-eye three-dimensional display apparatus, which can be implemented by software and/or hardware. For example, the apparatus can be a processing device in a naked-eye three-dimensional display system. The method includes steps S101 and S102.

Step S101 includes acquiring a stable human eye coordinate and a predicted human eye coordinate, where the predicted human eye coordinate is different from the stable human eye coordinate, and the predicted human eye coordinate is a human eye coordinate obtained by prediction and indicates a spatial position of a human eye at an image display instant.

The stable human eye coordinate is an unpredicted human eye coordinate, which is a real-time measured value or a value processed based on the real-time measured value, rather than an estimated value. The stable human eye coordinate is used to characterize the spatial position of the human eye at the instant when the human eye tracking device captures the human eye image. The stable human eye coordinate is a coordinate that is relatively stable but has a large time lag.

There is an inevitable system delay from the capture of the human eye position by the human eye tracking device to the final image display. The system delay refers to the delay of the display system executing the display method. The system delay includes both the delay caused by the hardware devices completing their working processes and the delay caused by the duration for executing the display method.

The predicted human eye coordinate is an estimated value. The predicted human eye coordinate is used to estimate the spatial position coordinate where the human eye will be located at the actual future image display instant. The purpose of the predicted human eye coordinate is to compensate for the system delay from when the human eye position is captured to when the final image is displayed, providing human eye position information that is more synchronized with the display instant. The predicted human eye coordinate is a coordinate with a small time lag but large noise.

Step S102 includes generating, according to the stable human eye coordinate and the predicted human eye coordinate, a display image for transmission to a display.

The delay caused by the hardware devices completing their working processes includes: the duration for the human eye tracking device to transmit the captured human eye image to the processing device, the duration for the display image to be transmitted from the processing device to the display, and the duration for the display to emit light for display according to the display image. The delay caused by executing the display method includes: the duration for acquiring the stable human eye coordinate and/or the predicted human eye coordinate, and the duration for generating the display image according to the stable human eye coordinate and the predicted human eye coordinate.

By the embodiments, through a strategy of functional separation, two contradictory demands are handled by using two different human eye coordinates respectively. In one embodiment, a display image is generated according to the stable human eye coordinate and the predicted human eye coordinate. The stable human eye coordinate is used to ensure that the generation of image content is jitter-free, and the forward-looking predicted human eye coordinate is used to optimize the real-time accuracy of image distribution to reduce crosstalk. This achieves both image stability and image correctness in fast dynamic scenes, thereby improving the user's viewing experience.

FIG. 2 is a flowchart of another naked-eye three-dimensional display method according to an embodiment. Referring to FIG. 2, the method includes steps S201 to S204.

Step S201 includes acquiring a stable human eye coordinate and a predicted human eye coordinate, where the predicted human eye coordinate is different from the stable human eye coordinate, and the predicted human eye coordinate is a human eye coordinate obtained by prediction and indicates a spatial position of a human eye at an image display instant.

In one embodiment, the step of acquiring the stable human eye coordinate and the predicted human eye coordinate includes steps A1 and A2.

Step A1 includes acquiring a human eye image, and acquiring an initial human eye coordinate according to the human eye image.

To obtain the initial human eye coordinate, the human eye tracking device captures the human eye image and transmits the human eye image to the processing device. The processing device runs a human eye tracking algorithm, locates the pupil or eye feature points from the human eye image, and converts them into a specific three-dimensional spatial coordinate system based on camera calibration parameters, to obtain the initial human eye coordinate. The initial human eye coordinate is directly read from a static picture, so the initial human eye coordinate is very stable. The initial human eye coordinate, the stable human eye coordinate, and the predicted human eye coordinate can all be represented by three-dimensional spatial coordinates. For example, the initial human eye coordinate is represented as (0, 0, 0), where the X coordinate value of the initial human eye coordinate is 0, the Y coordinate value of the initial human eye coordinate is 0, and the Z coordinate value of the initial human eye coordinate is 0.

Step A2 includes generating the stable human eye coordinate and the predicted human eye coordinate according to the initial human eye coordinate.

The initial human eye coordinate can be directly used as the stable human eye coordinate, or the stable human eye coordinate can be obtained by processing the initial human eye coordinate through smoothing, filtering, etc. The predicted human eye coordinate is estimated through a specific prediction algorithm, with the initial human eye coordinate as an input reference.

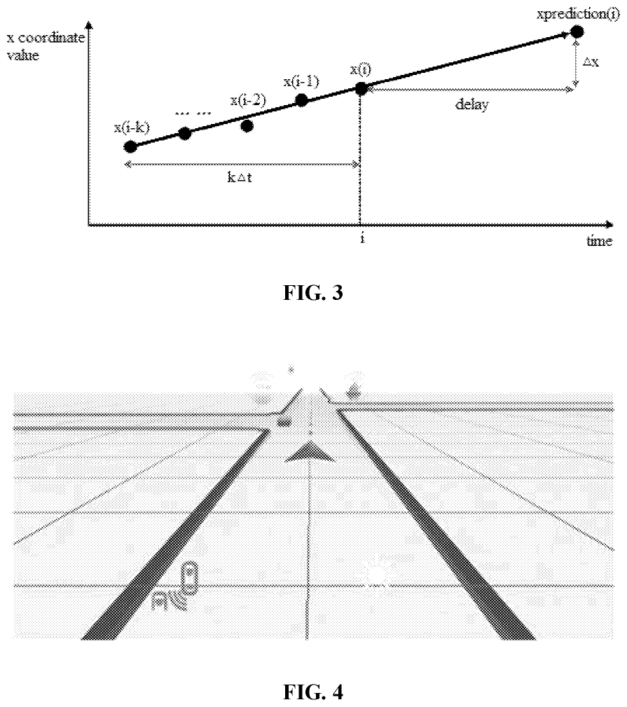

FIG. 3 is a schematic diagram of X coordinate values of human eye coordinates at different instants according to an embodiment. Referring to FIG. 3, the abscissa is time, and the ordinate is the X coordinate value. A dot in FIG. 3 represents the X coordinate value of the human eye coordinate at an instant, and a dot represents a sampling point. For example, x(i−k) is the X coordinate value of the human eye coordinate at instant i−k, x(i−2) is the X coordinate value of the human eye coordinate at instant i−2, and x(i−1) is the X coordinate value of the human eye coordinate at instant i−1, where 0<k<i. The instant i is the current instant. The current instant refers to the instant when the human eye tracking device captures the human eye position and captures the human eye image. The X coordinate value of the initial human eye coordinate at instant i is x(i). The X coordinate value of the predicted human eye coordinate at instant i is xprediction (i). It should be noted that xprediction(i) is a predicted value at the current instant, where:

$$xprediction ( i ) = x ( i ) + delay \times \frac{x ( i ) - x ( i - k )}{k Δ t} .$$

Δt is the time interval between two adjacent sampling points. For example, the time interval between instant i−1 and instant i is Δt. kΔt represents the sum of k time intervals corresponding to k+1 sampling points. delay is a delay parameter of the display system executing the display method. Delay represents the estimated duration from when the human eye position is captured by the human eye tracking device to the final image display. The numerical value of Delay can be obtained through actual product measurement before the naked-eye three-dimensional display system is shipped from factory. The difference between the X coordinate value of the predicted human eye coordinate at instant i and the X coordinate value of the initial human eye coordinate at instant i is Δx. That is to say, Δx=xprediction (i)−x(i). From the above formula and FIG. 3, it can be seen that

$$\frac{x ( i ) - x ( i - k )}{k Δ t}$$

is the slope obtained by linear fitting of multiple sampling points.

Similarly, the Y coordinate value of the predicted human eye coordinate at instant i is yprediction (i), and the Y coordinate value of the initial human eye coordinate at instant i is y(i), where:

$$yprediction ( i ) = y ( i ) + delay \times \frac{y ( i ) - y ( i - k )}{k Δ t} .$$

y(i−k) is the Y coordinate value of the human eye coordinate at instant y(i−k), delay is the delay parameter of the display system executing the display method, Δt is the time interval between two adjacent sampling points, where 0<k<i. Thus, the Y coordinate value of the predicted human eye coordinate at instant i can be obtained. Changes in the Z coordinate value of the human eye coordinate represent the movement of the human eye in the depth direction. The movement of the human eye in the depth direction has little impact on vision, so generally there is no need to predict the Z coordinate value of the human eye coordinate; for example, the Z coordinate value of the initial human eye coordinate at instant i is still used.

S202 includes performing image source capturing according to the stable human eye coordinate, to generate a left perspective image and a right perspective image.

FIG. 4 is a schematic diagram of a 3D image source according to an embodiment. Referring to FIG. 4, the 3D image source is not a recorded video but a 3D model. The 3D model is provided with three-dimensional objects, lighting, and reflections by the objects to the lighting. Image source capturing refers to, the 3D model is captured by a perspective camera from any perspective, to obtain a 2D image under that perspective. 2D refers to two-dimensional, and 3D refers to three-dimensional. The left perspective image and the right perspective image are 2D images captured under two different perspectives. The perspective camera is not a physical camera but a virtual camera.

In one embodiment, the step of performing image source capturing according to the stable human eye coordinate to generate the left perspective image and the right perspective image includes steps B1 and B2.

Step B1 includes setting a position of a left perspective camera and a position of a right perspective camera according to the stable human eye coordinate.

When the position of the left perspective camera changes, the capturing perspective of the left perspective camera changes, causing the content of the left perspective image captured by the left perspective camera to change. Similarly, when the position of the right perspective camera changes, the capturing perspective of the right perspective camera changes, causing the content of the right perspective image captured by the right perspective camera to change.

Step B2 includes generating the left perspective image according to the position of the left perspective camera, and generating the right perspective image according to the position of the right perspective camera.

The left perspective camera captures the left perspective image, and the right perspective camera captures the right perspective image.

Step S203 includes performing viewpoint rendering according to the predicted human eye coordinate, to generate a left-right eye allocation chart.

The display includes multiple sub-pixels. The left-right eye allocation chart includes multiple elements arranged in a two-dimensional array. The elements include left eye elements corresponding to sub-pixels displaying left eye content and right eye elements corresponding to sub-pixels displaying right eye content.

Step S204 includes performing display layout according to the left perspective image, the right perspective image, and the left-right eye allocation chart, to generate the display image.

Whether the human eye sees the display image jitter mainly depends on whether the perspective of the captured image jitters. In this embodiment, the left perspective camera and the right perspective camera are controlled according to the stable human eye coordinate that is not obtained by prediction. The stable human eye coordinate is very stable, thus mitigating the issue of screen jitter caused by the perspective switching back and forth over time. Screen jitter refers to the jitter of the display image. On the other hand, viewpoint rendering is performed according to the predicted human eye coordinate. The predicted human eye coordinate can compensate for the system delay, optimizing the real-time accuracy of image distribution to reduce crosstalk.

In other implementations, the order of the above steps S202 and S203 can also be exchanged, i.e., step S203 is performed before step S202. Or step S202 and step S203 are executed concurrently, that is to say, step S202 and step S203 are executed simultaneously.

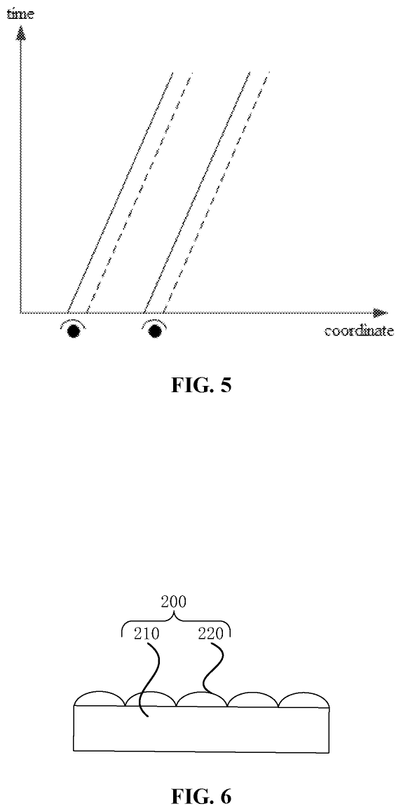

FIG. 5 is another schematic diagram of human eye coordinates at different instants according to an embodiment. Referring to FIG. 5, the abscissa represents coordinate values of the left eye and the right eye, for example, the X coordinate values of the left eye and the right eye, and the ordinate represents time. Two dashed lines respectively represent curves of the change of the real coordinates of the left eye and the right eye over time, and two solid lines respectively represent curves of the change of the stable human eye coordinates corresponding to the left eye and the right eye over time. Since the system delay is fixed, the duration corresponding to the system delay is the same at different instants, and the differences between the real coordinate of the human eye and the stable human eye coordinate at different instants are the same. In FIG. 5, this is shown as the same interval between the solid lines and the dashed lines at different instants. FIG. 5 illustrates a scenario where the user moves at a uniform speed. In this case, both the solid lines and the dashed lines are straight lines, and are parallel with each other.

In one embodiment, image source capturing is performed according to the stable human eye coordinate, and thus the generated left perspective image and right perspective image correspond to the human eye position at the capturing instant. During the user's movement, the content changes of the left perspective image and the right perspective image have a delay relative to the change of the human eye position. The display image is generated according to the left perspective image and the right perspective image, thus the content change of the display image has a delay relative to the movement of the human eye position. This delay does not cause changes in the display screen, thus having a minor impact on the user's viewing experience. Since the image source capturing is performed according to the stable human eye coordinate, jitter of the image capturing perspective caused by fluctuations in the human eye coordinate is avoided, thereby preventing jitter of the display screen. The jitter of the display screen has a greater impact on the user's viewing experience. In this embodiment, image stability is prioritized with selective acceptance of an amount of delay.

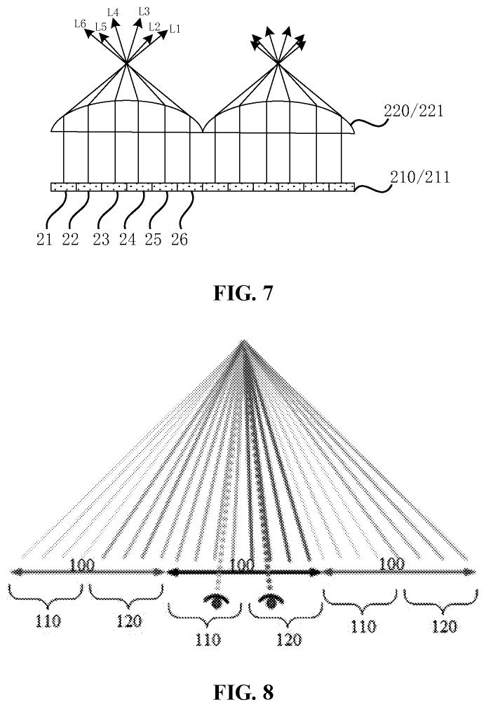

FIG. 6 is a schematic structural diagram of a display according to an embodiment, and FIG. 7 is a schematic diagram of a prism assembly splitting light rays according to an embodiment. Referring to FIG. 6 and FIG. 7, the display 200 includes a display panel 210 and a prism assembly 220. The display panel 210 includes multiple sub-pixels 211. The display panel 210 controls the luminous brightness of each sub-pixel 211 according to the data of the display image, and can display a preset screen. The prism assembly 220 is located on the propagation paths of the light rays emitted by the sub-pixels 211. The prism assembly 220 is configured to change the propagation direction of the light rays emitted by the sub-pixels 211, to generate a left eye view projected to the left eye and a right eye view projected to the right eye.

The number of viewpoints equals the number of images. In the two-viewpoint 3D display system according to this embodiment, the display panel 210 displays two images simultaneously. A subset of the sub-pixels 211 is configured to display one image, and the other sub-pixels 211 are configured to display the other image. After being spectroscopically split by the prism assembly 220, these two images are projected to the user's left eye and right eye, respectively.

Exemplarily, the prism assembly 220 includes multiple cylindrical prisms 221. In a direction perpendicular to the extension direction of the cylindrical prisms 221, one cylindrical prism 221 covers 5 to 20 sub-pixels 211. In one embodiment, in the direction perpendicular to the extension direction of the cylindrical prisms 221, one cylindrical prism 221 covers 8 to 9 sub-pixels 211.

In FIG. 7, one cylindrical prism 221 covering 6 sub-pixels 211, for example. Referring to FIG. 7, the 6 sub-pixels 211 are respectively a first sub-pixel 21, a second sub-pixel 22, a third sub-pixel 23, a fourth sub-pixel 24, a fifth sub-pixel 25, and a sixth sub-pixel 26. The cylindrical prism 221 deflects the light ray emitted by the first sub-pixel 21 to form a first light ray L1, deflects the light ray emitted by the second sub-pixel 22 to form a second light ray L2, deflects the light ray emitted by the third sub-pixel 23 to form a third light ray L3, deflects the light ray emitted by the fourth sub-pixel 24 to form a fourth light ray L4, deflects the light ray emitted by the fifth sub-pixel 25 to form a fifth light ray L5, and deflects the light ray emitted by the sixth sub-pixel 26 to form a sixth light ray L6. Any two of the first light ray L1, the second light ray L2, the third light ray L3, the fourth light ray L4, the fifth light ray L5, and the sixth light ray L6 have different propagation directions. Thus, the first light ray L1, the second light ray L2, the third light ray L3, the fourth light ray L4, the fifth light ray L5, and the sixth light ray L6 propagating in various directions in space can be divided into two groups. For example, the first light ray L1, the second light ray L2, and the third light ray L3 are grouped together for projection to the left eye. The fourth light ray L4, the fifth light ray L5, and the sixth light ray L6 are grouped together for projection to the right eye. Accordingly, the first sub-pixel 21, the second sub-pixel 22, and the third sub-pixel 23 are configured to display the image projected to the left eye, and the fourth sub-pixel 24, the fifth sub-pixel 25, and the sixth sub-pixel 26 are configured to display the image projected to the right eye.

FIG. 8 is a schematic diagram of an optical path for viewpoint rendering according to an embodiment. Referring to FIG. 1 to FIG. 8, after the step of generating the display image (e.g., step S102 or step S204), the naked-eye three-dimensional display method further includes: controlling the display 200 to emit light for display based on the display image, to form multiple periodically arranged viewing zones 100. The area within the divergence angle of light rays emitted by the sub-pixels 211, in the region below and with the same size as the cylindrical prism 221, and passing through the cylindrical prism 221 is a viewing zone 100. Or equivalently, the region between two light rays emitted by the same sub-pixel 211 onto two adjacent cylindrical prisms 221 is a viewing zone 100. The viewing zone 100 includes a left viewing sub-zone 110 displaying a left eye view and a right viewing sub-zone 120 displaying a right eye view.

Exemplarily, the first light ray L1, the second light ray L2, and the third light ray L3 are projected to the left viewing sub-zone 110, and the fourth light ray L4, the fifth light ray L5, and the sixth light ray L6 are projected to the right viewing sub-zone 120. Although FIG. 7 illustrates one light ray emitted by one sub-pixel 211, in practice, a sub-pixel 211 can emit many light rays, and the light rays emitted by the sub-pixel 211 form a continuous area. The landing points of the light rays in the viewing zone 100 also form a continuous area. As shown in FIG. 8, the landing points of the light rays from any single point on the sub-pixel 211 form a continuous area. Thus, the light rays emitted by multiple sub-pixels 211 on the display panel 210 and the landing points of the light rays in the viewing zone 100 have a surface-to-surface correspondence. The more sub-pixels 211 covered by one cylindrical prism 221, the better the continuity of light rays in the viewing zone 100 when the human eye moves, and the better the viewing experience of the user.

Referring to FIG. 8, multiple viewing zones 100 include a main viewing zone and repeated viewing zones. The main viewing zone corresponds to the position of the human eye. The main viewing zone is not a fixed spatial position but a spatial size range that changes with the human eye. The main viewing zone and the repeated viewing zones are concepts related to rendering. In product design, it is not the case that there is a display screen first and then the human eye watches the display screen at a specific position. Instead, the position of the human eye (e.g., the stable human eye coordinate or the predicted human eye coordinate, where when performing viewpoint rendering, this embodiment uses the predicted human eye coordinate) is first determined, and based on the position of the human eye, the corresponding sub-pixels 211 are traced back. Both the main viewing zone and the repeated viewing zones move with the human eye. Under normal working conditions of the naked-eye three-dimensional display system, the human eye cannot see the repeated viewing zones.

FIG. 9 is another schematic diagram of human eye coordinates at different instants according to an embodiment. Referring to FIG. 9, the abscissa represents the coordinate values of the left eye and the right eye, for example, the X coordinate values of the left eye and the right eye, and the ordinate represents time. The two dashed lines respectively represent the change curves of the real coordinates of the left eye and the right eye over time. The two outer solid polylines respectively represent the change curves of the predicted human eye coordinates corresponding to the left eye and the right eye over time. The middle solid polyline indicates the average value of the two side solid polylines. The ranges of the left viewing sub-zone 110 and the right viewing sub-zone 120 are determined according to the position of the middle solid polyline. That is to say, the ranges of the left viewing sub-zone 110 and the right viewing sub-zone 120 are determined according to the human eye coordinate. The turning points of the middle solid polyline are located on the boundary between the left viewing sub-zone 110 and the right viewing sub-zone 120. The inherent error and discreteness of the prediction algorithm itself will cause the predicted coordinate values to have unstable fluctuations over time. This fluctuation is manifested in FIG. 9 as the solid polylines fluctuating back and forth around the dashed lines.

In one embodiment, in a case that the predicted human eye coordinate has fluctuation, the amplitude of the fluctuation is insufficient to cause the left viewing sub-zone 110 to cover the spatial position of the right eye, and insufficient to cause the right viewing sub-zone 120 to cover the spatial position of the left eye. The ranges of the left sub-viewing zone 110 and the right sub-viewing zone 120 are determined by using the predicted human eye coordinate for viewpoint allocation. Although the predicted human eye coordinate fluctuates, the position of the left viewing sub-zone 110 covers the spatial position of the left eye but not the spatial position of the right eye, and the position of the right viewing sub-zone 120 covers the spatial position of the right eye but not the spatial position of the left eye. This reduces light ray crosstalk and adverse effects on the image seen by the human eye, and improves the viewing experience.

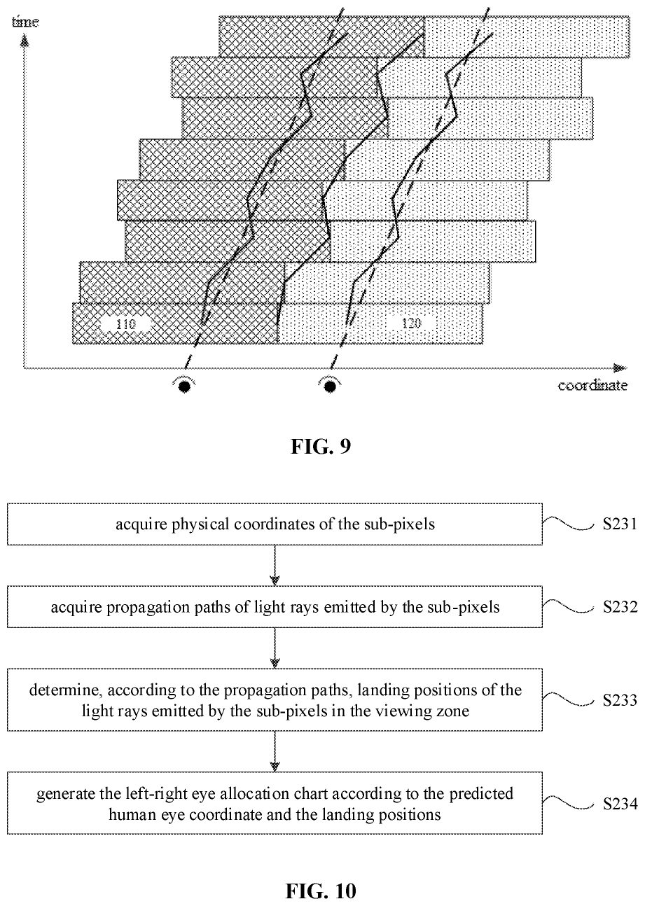

FIG. 10 is a detailed flowchart of step S203. Referring to FIG. 2 to FIG. 10, step S203 can include the following steps S231 to S234.

Step S231 includes acquiring physical coordinates of the sub-pixels.

The physical coordinate of each sub-pixel 211 in the display panel 210 is acquired. The physical coordinates of the sub-pixels 211 represent the precise positions of the sub-pixels 211 in three-dimensional space, thereby providing basic data for calculating the landing points (i.e., end points) of the light rays during subsequent backward ray tracing. The landing points of the light rays during backward ray tracing are the starting points of the light rays in the actual product.

Step S232 includes acquiring propagation paths of light rays emitted by the sub-pixels.

A propagation model in space is established for the light rays emitted from the sub-pixels 211 and passing through the optical elements in the naked-eye three-dimensional display system. For example, the path change after the light rays emitted from the sub-pixel 211 pass through the cylindrical prism 221 is calculated. Besides the cylindrical prisms 221, the optical elements may also include at least one of a plane mirror, a curved mirror, and a windshield. This step is used to establish a mapping relationship between the sub-pixels 211 and the light rays in space.

Step S233 includes determining, according to the propagation paths, landing positions of the light rays emitted by the sub-pixels in the viewing zone.

The spatial propagation information of the light rays is converted into quantifiable position points on a target observation plane. These quantifiable position points are the landing points in the viewing zone 100. If the human eye appears near this landing point, it can see this light ray. The landing point of the emitted light ray in the viewing zone 100 is the starting point of the light ray during backward ray tracing.

Step S234 includes generating the left-right eye allocation chart according to the predicted human eye coordinate and the landing positions.

With the starting points and landing points of the light rays and which sub-pixels 211 emits the light rays known, it can be determined, based on the position of the human eye (e.g., based on the predicted human eye coordinate), which light rays with landing points in the viewing zone 100 are allocated to the left eye and which light rays with landing points in the viewing zone 100 are allocated to the right eye. For example, light rays closer to the left dashed line in FIG. 8 are allocated to the left eye, and light rays closer to the right dashed line in FIG. 8 are allocated to the right eye. In this step, the display content of each sub-pixel 211 is allocated based on the predicted human eye coordinate and the landing position of the light ray.

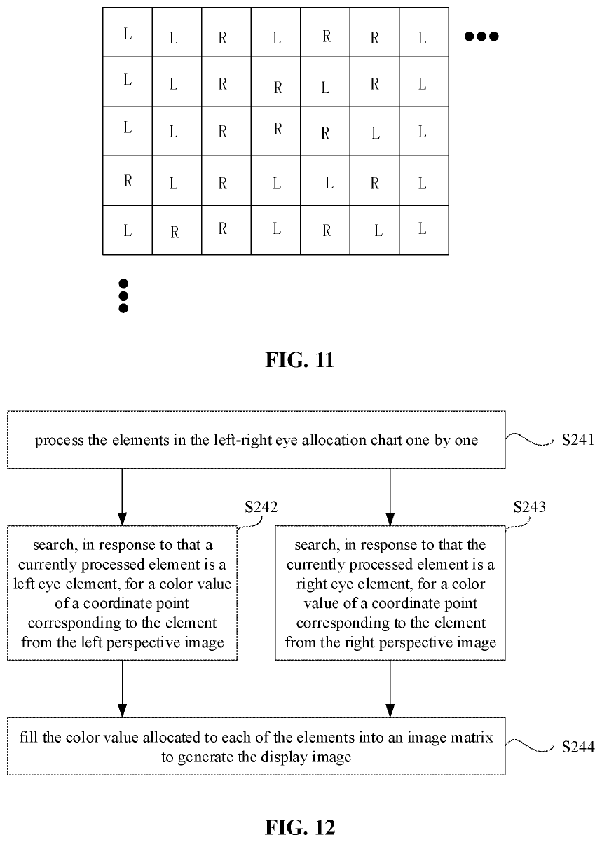

FIG. 11 is a schematic diagram of a left-right eye allocation chart according to an embodiment. Referring to FIG. 11, the left-right eye allocation chart is a two-dimensional data table corresponding to the distribution of the sub-pixels 211 in the display panel 210. Each element in the two-dimensional data table directly indicates the display content of the corresponding sub-pixel 211.

FIG. 12 is a detailed flowchart of step S204. Referring to FIG. 2 to FIG. 12, step S204 can include the following steps S241 to S 244.

Step S241 includes processing the elements in the left-right eye allocation chart one by one.

In this step, the elements in the left-right eye allocation chart are accessed and processed sequentially, ensuring that every element in the left-right eye allocation chart is processed. Accordingly, every sub-pixel 211 in the display panel 210 is processed.

Step S242 includes searching, in response to that a currently processed element is a left eye element, for a color value of a coordinate point corresponding to the element from the left perspective image.

If the currently processed element is a left eye element, the sub-pixel 211 corresponding to this element should display the content that the left eye should see. The left perspective image is searched for a color value of the coordinate point corresponding to the element, and the color value is mapped to the currently processed element. The color value is a channel value of a luminescent color of the sub-pixel 211 corresponding to the element.

For example, the left perspective image is a color image. The position of the coordinate point corresponding to the element currently being processed in the color image is (0, 0, 5). A color of the unit at the position (0, 0, 5) in the left perspective image is white (255, 255, 255). (255, 255, 255) represents a grayscale value of 255 for the red channel, a grayscale value of 255 for the green channel, and a grayscale value of 255 for the blue channel. The sub-pixel 211 in the display panel 210 corresponding to the currently processed element is a green sub-pixel, so the grayscale value 255 of the green channel is mapped to the currently processed element. When the display panel 210 emits light for display, the grayscale of the sub-pixel 211 in the display panel 210 corresponding to the currently processed element is 255.

For example, in FIG. 11, L represents that the display content of the corresponding sub-pixel 211 is for a left eye, and the element denoted by L is a left eye element.

Step S243 includes searching, in response to that the currently processed element is a right eye element, for a color value of a coordinate point corresponding to the element from the right perspective image.

If the currently processed element is a right eye element, the sub-pixel 211 corresponding to this element should display the content that the right eye should see. The right perspective image is searched for the color value of the coordinate point corresponding to the element, and the color value is mapped to the currently processed element.

For example, in FIG. 11, R represents that the display content of the corresponding sub-pixel 211 is for a right eye, and the element denoted by R is a right eye element.

Step S244 includes filling the color value allocated to each of the elements into an image matrix to generate the display image.

This embodiment is to provide a display image to the display 200. Each image pixel in the display image has a grayscale value. The data of an image pixel corresponds to a numerical value for controlling the display grayscale of a respective sub-pixel 211. The left perspective image and the right perspective image can be understood as databases. The left perspective image or the right perspective image is searched for the color value of the coordinate point corresponding to the element, and the color value is associated with the currently processed element. For example, the color value is filled into a unit at the same position as the currently processed element in the image matrix. In this embodiment, the result of the two-viewpoint rendering and the two perspective images generated by the image source capturing are used as inputs of a 3D image layout algorithm to perform image layout, thereby generating image data that can be utilized by the display panel 210.

The units in the left perspective image (or the right perspective image) do not exactly correspond one to one with the elements in the left-right eye allocation chart. For example, to correct high-order distortion and image deformation, the numbers of rows and columns of the units are not in a one-to-one correspondence with those of the elements.

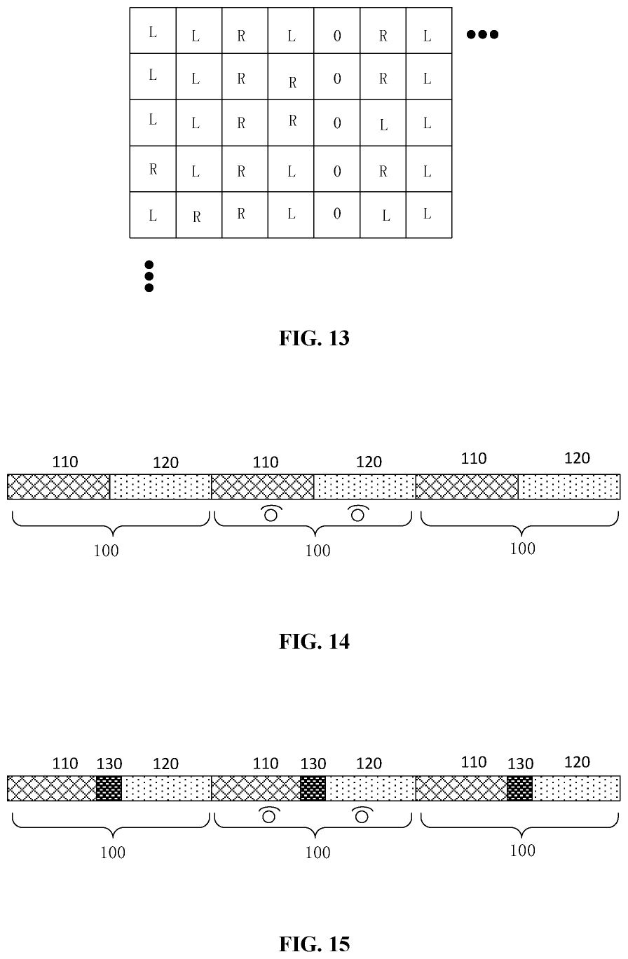

FIG. 13 is a schematic diagram of another left-right eye allocation chart according to an embodiment. Referring to FIG. 7 and FIG. 13, the elements further include black zone elements corresponding to sub-pixels 211 not emitting light; if the element is a black zone element, the color value allocated to the element is zero. As shown in FIG. 11, the element denoted by 0 is a black zone element. 0 represents that the corresponding sub-pixel 211 does not display content for a left eye or a right eye. Therefore, the sub-pixel 211 corresponding to the element denoted by 0 can be configured to not display anything, and the sub-pixel 211 does not emit light.

FIG. 14 is a schematic diagram of a distribution of viewing zones according to an embodiment. Referring to FIG. 8, FIG. 11, and FIG. 14, the left viewing sub-zone 110 is the angular area formed by the light emission of sub-pixels 211 corresponding to all left eye elements. The right viewing sub-zone 120 is the angular area formed by the light emission of sub-pixels 211 corresponding to all right eye elements. Within the same viewing zone 100, the left viewing sub-zone 110 and the right viewing sub-zone 120 are adjacent to each other. The left viewing sub-zone 110 in a viewing zone 100 is adjacent to the right viewing sub-zone 120 in an adjacent viewing zone 100, and the right viewing sub-zone 120 in a viewing zone 100 is adjacent to the left viewing sub-zone 110 in an adjacent viewing zone 100.

FIG. 15 is a schematic diagram of another distribution of viewing zones according to an embodiment. Referring to FIG. 13 and FIG. 15, the viewing zone 100 further includes a black viewing sub-zone 130. The black viewing sub-zone 130 is the angular area formed by the light emission of sub-pixels 211 corresponding to all black zone elements. Within the same viewing zone 100, the black viewing sub-zone 130 is located between the left viewing sub-zone 110 and the right viewing sub-zone 120. The black viewing sub-zone 130 is a non-light-emitting area. Since the black viewing sub-zone 130 is far from both the left eye and the right eye, there is no need to assign values to the black zone elements corresponding to the black viewing sub-zone 130, thereby reducing the amount of calculation and speeding up the reaction of the naked-eye three-dimensional display system.

Exemplarily, the black viewing sub-zone 130 is far from both the left eye and the right eye. The black viewing sub-zone 130 covers neither the spatial position of the left eye nor the spatial position of the right eye, thus having no adverse effects on the image seen by the human eyes. Along the direction of repeated arrangement of the viewing zones 100, the width of the black viewing sub-zone 130 is smaller than the width of the left viewing sub-zone 110, and smaller than the width of the right viewing sub-zone 120.

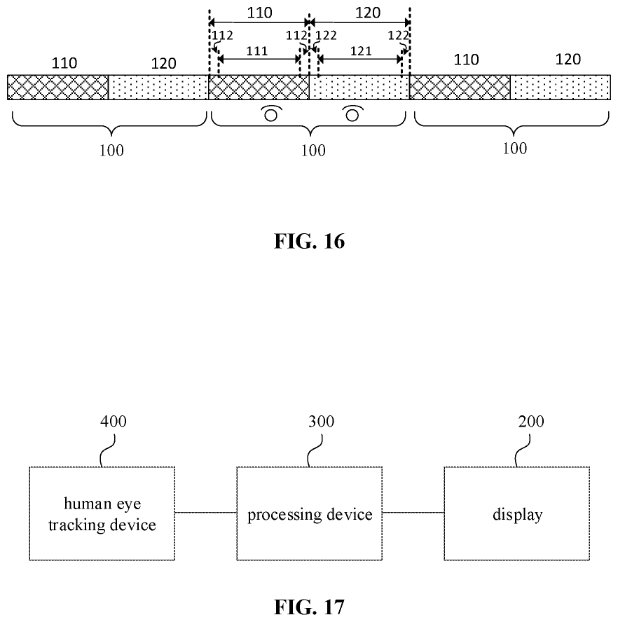

FIG. 16 is a schematic diagram of yet another distribution of viewing zones according to an embodiment. Referring to FIG. 16, the left viewing sub-zone 110 includes a first internal region 111 and a first boundary region 112. The first boundary region 112 is located between the right viewing sub-zone 120 and the first internal region 111. The right viewing sub-zone 120 includes a second internal region 121 and a second boundary region 122. The second boundary region 122 is located between the left viewing sub-zone 110 and the second internal region 121. The first internal region 111 and the second internal region 121 are internal regions of viewing zone, and the first boundary region 112 and the second boundary region 122 are boundary regions of viewing zone. The rates of change of the brightness proportions of the left eye view and the right eye view in the boundary regions of viewing zone are greater than the rates of change of the brightness proportions of the left eye view and the right eye view in the internal regions of viewing zone. Exemplarily, in the first internal region 111, there may be a small amount of light rays from the right eye view. In general, the proportion of the brightness of the right eye view in the brightness of the first internal region 111 is less than 2%. In the second internal region 121, there may be a small amount of light rays from the left eye view. In general, the proportion of the brightness of the left eye view in the brightness of the second internal region 121 is less than 2%. In the boundary regions of viewing zone, there is a significant amount of light rays from the left eye view and the right eye view. The brightness of the right eye view in the first internal region 111 is less than the brightness of the right eye view in the boundary regions of viewing zone, and the brightness of the left eye view in the second internal region 121 is less than the brightness of the left eye view in the boundary regions of viewing zone. The brightness proportion of the right eye view in the first internal region 111 is less than the brightness proportions of the right eye view in the boundary regions of viewing zone, and the brightness proportion of the left eye view in the second internal region 121 is less than the brightness proportions of the left eye view in the boundary regions of viewing zone. The brightness proportion is the proportion of the brightness of the left eye view or the right eye view in the brightness of the region displaying the left eye view or the right eye view.

In the first internal region 111, the brightness proportion of the left eye view and the brightness proportion of the right eye view remain unchanged. In the second internal region 121, the brightness proportion of the left eye view and the brightness proportion of the right eye view also remain unchanged. That is, in the internal regions of viewing zone, the brightness proportion of the left eye view and the brightness proportion of the right eye view remain unchanged, and the rates of change of the brightness proportions of the left eye view and the right eye view is 0. In the boundary regions of viewing zone, the brightness of the left eye view and the right eye view changes over time, and the brightness proportions of the left eye view and the right eye view fluctuate over time. The rates of change of the brightness proportions of the left eye view and the right eye view in the boundary regions of viewing zone are greater than 0. The rates of change of the brightness proportions of the left eye view and the right eye view in the boundary regions of viewing zone are greater than the rates of change of the brightness proportions of the left eye view and the right eye view in the internal regions of viewing zone.

In one embodiment, at least one of the maximum value of the fluctuation amplitude, the fluctuation frequency, and the average value of the fluctuation amplitude of the predicted human eye coordinate over time is greater than that of the stable human eye coordinate. That is, at least one of the following conditions is satisfied: the maximum value of the fluctuation amplitude of the predicted human eye coordinate over time is greater than the maximum value of the fluctuation amplitude of the stable human eye coordinate over time; the fluctuation frequency of the predicted human eye coordinate over time is greater than the fluctuation frequency of the stable human eye coordinate over time; the average value of the fluctuation amplitude of the predicted human eye coordinate over time is greater than the average value of the fluctuation amplitude of the stable human eye coordinate over time.

FIG. 17 is a structural block diagram of a naked-eye three-dimensional display system according to an embodiment. Referring to FIG. 6, FIG. 7, and FIG. 17, the naked-eye three-dimensional display system includes a human eye tracking device 400, a processing device 300, and a display 200. The human eye tracking device 400 captures a human eye image. The processing device 300 acquires the human eye image, acquires an initial human eye coordinate according to the human eye image, generates a stable human eye coordinate and a predicted human eye coordinate according to the initial human eye coordinate, and generates a display image according to the stable human eye coordinate and the predicted human eye coordinate, where the predicted human eye coordinate is different from the stable human eye coordinate, and the predicted human eye coordinate is a human eye coordinate obtained by prediction and indicates a spatial position of a human eye at an image display instant. The display 200 emits light for display based on the display image, to form multiple periodically arranged viewing zones 100.

In embodiments, the display includes a display panel and a prism assembly, the display panel includes multiple sub-pixels, and the prism assembly is located on propagation paths of light rays emitted by the sub-pixels.

In embodiments, the viewing zone includes a left viewing sub-zone displaying a left eye view and a right viewing sub-zone displaying a right eye view. The left viewing sub-zone includes a first internal region and a first boundary region, the first boundary region being located between the right viewing sub-zone and the first internal region. The right viewing sub-zone includes a second internal region and a second boundary region, the second boundary region being located between the left viewing sub-zone and the second internal region. The first internal region and the second internal region are internal regions of viewing zone, and the first boundary region and the second boundary region are boundary regions of viewing zone. Image switching frequencies of the boundary regions of viewing zone are greater than image switching frequencies of the internal regions of viewing zone. For example, an image switching frequency of the first boundary region is greater than that of the first internal region, and an image switching frequency of the second boundary region is greater than that of the second internal region. In another example, an image switching frequency of the second boundary region is greater than that of the first internal region, and an image switching frequency of the first boundary region is greater than that of the second internal region. In embodiments, image switching frequencies of the first and second boundary regions are greater than those of the first and second internal regions.

In embodiments, a fluctuation frequency of the predicted human eye coordinate over time is greater than a fluctuation frequency of the stable human eye coordinate over time.

In embodiments, the processing device 300 of the naked-eye three-dimensional display system is configured to execute the above naked-eye three-dimensional display method. The processing device 300, through a strategy of functional separation, satisfies two contradictory demands using two different human eye coordinates respectively. In one embodiment, the display image is generated according to the stable human eye coordinate and the predicted human eye coordinate. The stable human eye coordinate is used to ensure that the generation of image content is jitter-free, and the forward-looking predicted human eye coordinate is used to optimize the real-time accuracy of image distribution to reduce crosstalk. This achieves both image stability and image correctness in fast dynamic scenes, thereby improving the user's viewing experience.

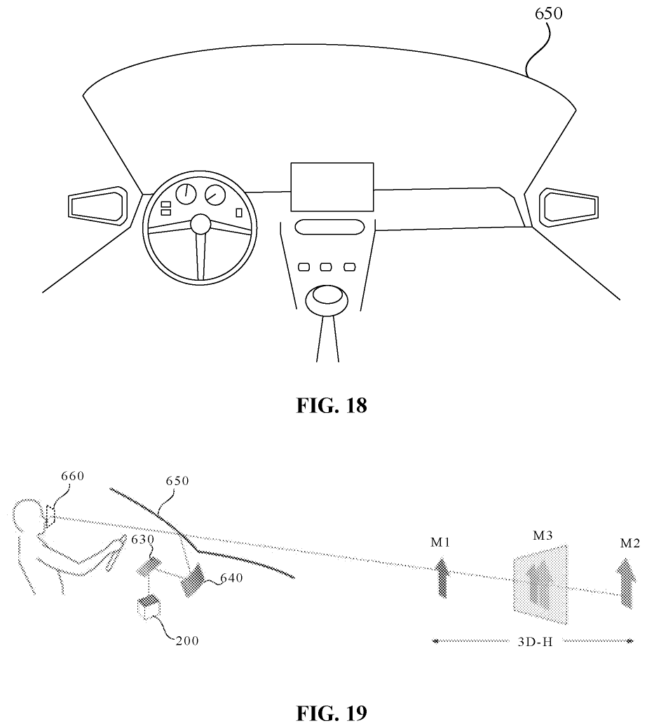

FIG. 18 is a schematic diagram of a vehicle according to an embodiment, and FIG. 19 is a schematic diagram of an optical path of a vehicle according to an embodiment. Referring to FIG. 6, FIG. 17 to FIG. 19, the vehicle includes the naked-eye three-dimensional display system in the above embodiments, thereby having the beneficial effects of the above naked-eye three-dimensional display system, i.e., achieving both image stability and image correctness in fast dynamic scenes, thereby improving the user's viewing experience.

Exemplarily, the naked-eye three-dimensional display system may further include at least one light adjustment component. The at least one light adjustment component is located on the optical path of the image beam emitted from the display 200, and the light adjustment component is at least used to adjust the propagation direction of the image beam.

As an example, the at least one light adjustment component includes a plane mirror 630 and a curved mirror 640. The light emitted from the display 200 can be reflected by the plane mirror 630 and the curved mirror 640, and transmitted to an imaging assembly 650. The imaging assembly 650 can reflect a portion of the light rays to an eyebox 660, and form a virtual image on the other side of the imaging assembly 650, allowing the driver to clearly see the key information of the vehicle without taking their eyes off the road, understanding key information such as the vehicle's operating status, navigation guidance, and safety warnings in time, to make corresponding driving decisions and operations.

The imaging assembly 650 can be the vehicle's windshield. In other embodiments, the imaging assembly 650 can be a separate display screen. The vehicle can be, for example, an automobile, an airplane, or a ship.

The light rays emitted by the display 200 are reflected by the imaging assembly 650 to the eyebox 660. The user's left eye and right eye can see the virtual images of the image beams with different emission angles on the first parallax image plane M1 and the second parallax image plane M2, respectively. Due to the parallax effect, the user sees a 3D virtual image on the third parallax image plane M3. 3D-H refers to the 3D depth of the 3D virtual image.

Exemplarily, the human eye tracking device 400 includes a human eye tracking camera, which is configured to capture the human eye image. The human eye tracking device 400 can be disposed on the windshield or below the steering wheel. The position of the human eye tracking device 400 is not limited in this embodiment.

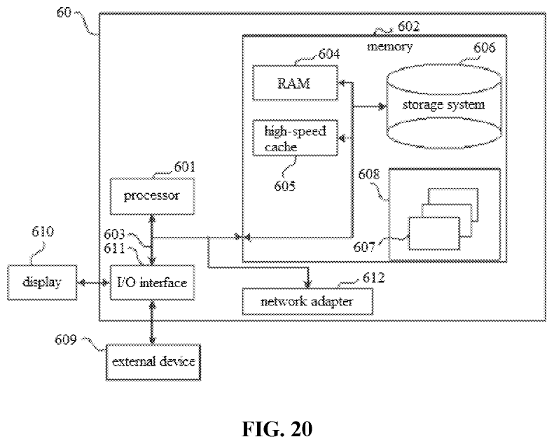

FIG. 20 is a structural schematic diagram of a computer device according to an embodiment. Referring to FIG. 20, the computer device 60 includes a memory 602, a processor 601, and a computer program stored in the memory 602 and executable on the processor. When the processor 601 executes the program, the method in the above embodiments is implemented. FIG. 20 shows a block diagram of an exemplary computer device suitable for implementing the embodiments of the present disclosure. The computer device 60 shown in FIG. 20 is only an example and should not bring any limitation to the functions and scope of use of the embodiments of the present disclosure. As shown in FIG. 20, the computer device 60 is represented in the form of a general-purpose computing device. The components of the computer device 60 may include but are not limited to: one or more processors 601, a system memory 602, and a bus 603 connecting different system components (including the system memory 602 and the processor 601).

The bus 603 represents one or more of several types of bus structures, including a memory bus or memory controller, a peripheral bus, an accelerated graphics port, a processor, or a local bus using any of a variety of bus architectures. By way of example, such architectures include but are not limited to the Industry Standard Architecture (ISA) bus, the Micro Channel Architecture (MCA) bus, the Enhanced ISA bus, the Video Electronics Standards Association (VESA) local bus, and the Peripheral Component Interconnect (PCI) bus.

The computer device 60 typically includes a variety of computer system readable media. Such media may be any available media that can be accessed by the computer device 60, including volatile and non-volatile media, removable and non-removable media.

The system memory 602 may include computer system readable media in the form of volatile memory, such as Random Access Memory (RAM) 604 and/or high-speed cache memory 605. The computer device 60 may further include other removable/non-removable, volatile/non-volatile computer system storage media. By way of example only, the storage system 606 can be used for reading from and writing to non-removable, non-volatile magnetic media (not shown in FIG. 20, commonly referred to as a “hard drive”). Although not shown in FIG. 20, a disk drive for reading from and writing to a removable non-volatile disk (e.g., a “floppy disk”), and an optical disk drive for reading from or writing to a removable non-volatile optical disk (such as a CD-ROM, DVD-ROM, or other optical media) can be provided. In these instances, each drive can be connected to the bus 603 by one or more data media interfaces. The system memory 602 may include at least one program product, the program product having a set of (e.g., at least one) program modules, and these program modules are configured to perform the functions of various embodiments of the present disclosure.

A program/utility tool 608 having a set (at least one) of program modules 607, may be stored in, for instance, the system memory 602. Such program modules 607 include but are not limited to an operating system, one or more application programs, other program modules, and program data. Each of these examples or a combination thereof may include an implementation of a networking environment. The program modules 607 generally perform the functions and/or methods of the described embodiments of the present disclosure.

The computer device 60 can also communicate with one or more external devices 609 (e.g., a keyboard, a pointing device, a display 610, etc.), can also communicate with one or more devices that enable a user to interact with the device, and/or communicate with any device (e.g., a network card, a modem, etc.) that enables the computer device 60 to communicate with one or more other computing devices. Such communication can occur through an Input/Output (I/O) interface 611. Moreover, the computer device 60 can also communicate with one or more networks (e.g., a Local Area Network (LAN), a Wide Area Network (WAN), and/or a public network, such as the Internet) through a network adapter 612. As shown in FIG. 20, the network adapter 612 communicates with other modules of the computer device 60 through the bus 603. Although not shown in the figure, other hardware and/or software modules can be used in conjunction with the computer device 60, including but not limited to: microcode, device drivers, redundant processing units, external disk drive arrays, RAID systems, tape drives, and data backup storage systems.

The processor 601 executes various functional applications and data processing by running the programs stored in the system memory 602.

An embodiment of the present disclosure also provides a computer-readable storage medium, on which a computer program is stored. When the program is executed by a processor, the method described in the above embodiments can be implemented.

The computer storage medium of the embodiment of the present disclosure may be any combination of one or more computer-readable media. The computer-readable medium may be a computer-readable signal medium or a computer-readable storage medium. The computer-readable storage medium may be, for example, but is not limited to, an electronic, magnetic, optical, electromagnetic, infrared, or semiconductor system, apparatus, or device, or any combination thereof. More specific examples (a non-exhaustive list) of the computer-readable storage medium include: an electrical connection having one or more wires, a portable computer disk, a hard disk, Random Access Memory (RAM), Read-Only Memory (ROM), Erasable Programmable Read-Only Memory (EPROM or Flash memory), optical fiber, a portable Compact Disc Read-Only Memory (CD-ROM), an optical storage device, a magnetic storage device, or any suitable combination of the foregoing. In this document, a computer-readable storage medium may be any tangible medium that contains or stores a program, and the program can be used by or in conjunction with an instruction execution system, apparatus, or device.

A computer-readable signal medium may include a propagated data signal with computer-readable program code embodied therein, for example, in baseband or as part of a carrier wave. Such a propagated data signal may take many forms, including but not limited to, electromagnetic signals, optical signals, or any suitable combination thereof. A computer-readable signal medium may also be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for the present disclosure may be written in one or more programming languages or a combination thereof, including an object-oriented programming language such as Java, Smalltalk, C++, and also conventional procedural programming languages, such as the “C” language or similar programming languages. The program code may be executed entirely on the user's computer, partly on the user's computer, as a stand-alone software package, partly on the user's computer and partly on a remote computer, or entirely on the remote computer or server. In the scenario involving the remote computer, the remote computer may be connected to the user's computer through any type of network, including a Local Area Network (LAN) or a Wide Area Network (WAN), or the connection may be made to an external computer (for example, through the Internet using an Internet Service Provider).

Note that the above are only some preferred embodiments of the present disclosure and the applied technical principles. It should be understood that the present disclosure is not limited to the specific embodiments described herein, and various changes, readjustments, mutual combinations, and substitutions can be made in the art without departing from the protection scope of the present disclosure. Therefore, although the present disclosure has been described in detail through the above embodiments, the present disclosure is not limited only to the above embodiments, and can also include more other equivalent embodiments without departing from the idea of the present disclosure, while the scope of the present disclosure is determined by the scope of the appended claims.

What is claimed is:

1. A naked-eye three-dimensional display method, the method comprising:
acquiring a stable human eye coordinate and a predicted human eye coordinate, wherein the predicted human eye coordinate is different from the stable human eye coordinate, and the predicted human eye coordinate is a human eye coordinate obtained by prediction and indicates a spatial position of a human eye at an image display instant;
generating, according to the stable human eye coordinate and the predicted human eye coordinate, a display image for transmission to a display.

2. The naked-eye three-dimensional display method according to claim 1, wherein generating, according to the stable human eye coordinate and the predicted human eye coordinate, the display image for transmission to the display comprises:
performing image source capturing according to the stable human eye coordinate to generate a left perspective image and a right perspective image;
generating the display image according to the left perspective image, the right perspective image, and the predicted human eye coordinate.

3. The naked-eye three-dimensional display method according to claim 2, wherein performing the image source capturing according to the stable human eye coordinate to generate the left perspective image and the right perspective image comprises:
setting a position of a left perspective camera and a position of a right perspective camera according to the stable human eye coordinate;
generating the left perspective image according to the position of the left perspective camera, and generating the right perspective image according to the position of the right perspective camera.

4. The naked-eye three-dimensional display method according to claim 2, wherein the display comprises a plurality of sub-pixels; and
generating, according to the stable human eye coordinate and the predicted human eye coordinate, the display image for transmission to the display further comprises:
performing viewpoint rendering according to the predicted human eye coordinate to generate a left-right eye allocation chart, wherein the left-right eye allocation chart comprises a plurality of elements arranged in a two-dimensional array, and the plurality of elements comprise left eye elements corresponding to sub-pixels displaying left eye content and right eye elements corresponding to sub-pixels displaying right eye content;
performing display layout according to the left perspective image, the right perspective image, and the left-right eye allocation chart to generate the display image.

5. The naked-eye three-dimensional display method according to claim 4, wherein performing the viewpoint rendering according to the predicted human eye coordinate to generate the left-right eye allocation chart comprises:
acquiring physical coordinates of the plurality of sub-pixels;
acquiring propagation paths of light rays emitted by the plurality of sub-pixels;
determining landing positions of the light rays emitted by the plurality of sub-pixels in a viewing zone according to the propagation paths;
generating the left-right eye allocation chart according to the predicted human eye coordinate and the landing positions.

6. The naked-eye three-dimensional display method according to claim 4, wherein performing the display layout according to the left perspective image, the right perspective image, and the left-right eye allocation chart to generate the display image comprises:
processing the plurality of elements in the left-right eye allocation chart one by one;
searching, in response to that a currently processed element is a left eye element, for a color value of a coordinate point corresponding to the element from the left perspective image;
searching, in response to that the currently processed element is a right eye element, for a color value of a coordinate point corresponding to the element from the right perspective image, the color value being a channel value of a luminescent color of a sub-pixel corresponding to the element;
filling the color value allocated to each of the plurality of elements into an image matrix to generate the display image.

7. The naked-eye three-dimensional display method according to claim 6, wherein the plurality of elements further comprise black zone elements corresponding to sub-pixels not emitting light; and
in response to that an element is one of the black zone elements, the color value allocated to the element is zero.

8. The naked-eye three-dimensional display method according to claim 1, wherein acquiring the stable human eye coordinate and the predicted human eye coordinate comprises:
acquiring a human eye image, and acquiring an initial human eye coordinate according to the human eye image; and
generating the stable human eye coordinate and the predicted human eye coordinate according to the initial human eye coordinate.

9. The naked-eye three-dimensional display method according to claim 8, wherein an X coordinate value of the predicted human eye coordinate at instant i is x_{prediction} (i), and an X coordinate value of the initial human eye coordinate at instant i is x(i), wherein:
$$xprediction ( i ) = x ( i ) + delay \times \frac{x ( i ) - x ( i - k )}{k Δ t} ,$$
wherein, 0<k<i, Δt is a time interval between two adjacent sampling points, x(i−k) is an X coordinate value of the human eye coordinate at instant i−k, and, delay is a delay parameter of a display system executing the naked-eye three-dimensional display method.

10. The naked-eye three-dimensional display method according to claim 1, wherein after generating, according to the stable human eye coordinate and the predicted human eye coordinate, the display image for transmission to the display, the method further comprises:
controlling the display to emit light for display based on the display image, to forming a plurality of periodically arranged viewing zones, wherein the viewing zone comprise a left viewing sub-zone displaying a left eye view and a right viewing sub-zone displaying a right eye view.

11. The naked-eye three-dimensional display method according to claim 10, wherein within the same viewing zone, the left viewing sub-zone and the right viewing sub-zone are adjacent to each other.

12. The naked-eye three-dimensional display method according to claim 10, wherein the viewing zone further comprises a black viewing sub-zone, and within the same viewing zone, the black viewing sub-zone is located between the left viewing sub-zone and the right viewing sub-zone.

13. The naked-eye three-dimensional display method according to claim 10, wherein the left viewing sub-zone comprises a first internal region and a first boundary region, the first boundary region being located between the right viewing sub-zone and the first internal region;
the right viewing sub-zone comprises a second internal region and a second boundary region, the second boundary region being located between the left viewing sub-zone and the second internal region;
the first internal region and the second internal region are internal regions of viewing zone, and the first boundary region and the second boundary region are boundary regions of viewing zone;
rates of change of brightness proportions of the left eye view and the right eye view in the boundary regions of viewing zone are greater than rates of change of brightness proportions of the left eye view and the right eye view in the internal regions of viewing zone, the brightness proportion being a proportion of a brightness of the left eye view or the right eye view in a brightness of the region displaying the left eye view or the right eye view.

14. The naked-eye three-dimensional display method according to claim 10, wherein in a case that the predicted human eye coordinate has fluctuation, an amplitude of the fluctuation is insufficient to cause the left viewing sub-zone to cover a spatial position of the right eye, and insufficient to cause the right viewing sub-zone to cover a spatial position of the left eye.

15. The naked-eye three-dimensional display method according to claim 1, wherein at least one of a maximum value of a fluctuation amplitude, a fluctuation frequency, and an average value of the fluctuation amplitude of the predicted human eye coordinate over time is greater than a maximum value of a fluctuation amplitude, a fluctuation frequency, and an average value of the fluctuation amplitude of the stable human eye coordinate over time.

16. The naked-eye three-dimensional display method according to claim 2, wherein during movement of a user, content changes of the left perspective image and the right perspective image have a delay relative to a change of a human eye position.

17. A naked-eye three-dimensional display system, comprising:
a human eye tracking device, configured to capture a human eye image;
a processing device, configured to acquire the human eye image, acquire an initial human eye coordinate according to the human eye image, generate a stable human eye coordinate and a predicted human eye coordinate according to the initial human eye coordinate, and generate a display image according to the stable human eye coordinate and the predicted human eye coordinate, wherein the predicted human eye coordinate is different from the stable human eye coordinate, and the predicted human eye coordinate is a human eye coordinate obtained by prediction, and indicates a spatial position of a human eye at an image display instant;
a display, configured to emit light for display based on the display image, to form a plurality of periodically arranged viewing zones.

18. The naked-eye three-dimensional display system according to claim 17, wherein the display comprises a display panel and a prism assembly, the display panel comprises a plurality of sub-pixels, and the prism assembly is located on propagation paths of light rays emitted by the plurality of sub-pixels.

19. The naked-eye three-dimensional display system according to claim 17, wherein the viewing zone comprises a left viewing sub-zone displaying a left eye view and a right viewing sub-zone displaying a right eye view;
the left viewing sub-zone comprises a first internal region and a first boundary region, the first boundary region being located between the right viewing sub-zone and the first internal region;
the right viewing sub-zone comprises a second internal region and a second boundary region, the second boundary region being located between the left viewing sub-zone and the second internal region;
the first internal region and the second internal region are internal regions of viewing zone, and the first boundary region and the second boundary region are boundary regions of viewing zone;
image switching frequencies of the boundary regions of viewing zone are greater than image switching frequencies of the internal regions of viewing zone.

20. The naked-eye three-dimensional display system according to claim 17, wherein a fluctuation frequency of the predicted human eye coordinate over time is greater than a fluctuation frequency of the stable human eye coordinate over time.
